(19) United States
(12) Patent Application Publication
(10) Pub. No.: US 2009/0307168 A1
(43) Pub. Date: Dec. 10, 2009

(54) Systems and methods for photo-based content discovery and recommendation

(75) Inventors: Edward C. Bockius, Boston, MA (US); Jeff Giarraputo, Denver, CO (US)

Correspondence Address: WILSON, SONSINI, GOODRICH & ROSATI, 650 PAGE MILL ROAD, PALO ALTO, CA, 94304-1050, US

(73) Assignee: LikeMe Inc., Culver City, CA (US)

(21) Appl. No.: 12/387,701

(22) Filed: May 6, 2009

Related U.S. Application Data
(60) Provisional application No. 61/050,946, filed on May 6, 2008.

(51) Int. Cl. G06N 5/02

(52) U.S. Cl. 706/46; 707/104.1

(57) ABSTRACT

Described are systems and methods for photo-based content discovery and recommendation. The methods and systems disclosed provide a photo-based website for allowing users to discover places, people and activity of similar likes and preferences.

This application claims priority to the provisional application Ser. No. 61/050,946 filed on May 6, 2008.

### BACKGROUND OF THE INVENTION

When someone wants information about a particular goods or service, they typically ask friends and colleagues or conduct multiple searches on the internet. However, current search engines and websites on the internet have various limitations. For example, there has been no predictive capability such as “based on the hotels you have stayed in and liked and those you have disliked, here are the hotels you would like in Paris” or “here are the hotels your friends have stayed in Paris and recommend.” Certain social-networks may provide some help, but information in the social networks are private and not available to the public.

Therefore, it remains desirable for certain websites or other systems to have the ability to publicly show likes and preferences to one another. It is also further beneficial if such systems can be broadly applicable, e.g. in any international market and/or low cost.

### SUMMARY OF THE INVENTION

Described are systems and methods for photo-based content discovery and recommendation. The methods and systems disclosed provide a photo-based website for allowing users to discover places and activity of similar likes and preferences.

In one aspect are photo-based content discovery and recommendation systems, executable by a computer, for internet users comprising,
(a) a database;
(b) a logic for creating personal profile in the database based on inputs from a first user;
(c) a logic for determining a degree of likes and preferences for each item listed in the first user's personal profile; and
(d) a logic for discovering and recommending the items listed in the first user's personal profile from the database to a second user

In some embodiments of this aspect, the systems disclosed use internet for obtaining information of the items. In some embodiment of this aspect, the systems use a wireless connection to the internet. In some embodiment of this aspect, the systems comprise a wireless hand-held device for displaying said items.

In some embodiments, said database comprises a collection of pre-selected personal profiles. In some embodiments, said database comprises a collection of pre-selected items. In some embodiments, the items are selected from the group consisting of hotels, bars, restaurants, activities, and any combinations thereof. In some embodiments, the database comprises at least one pre-populated archetypes of profiles for a particular city.

In some embodiments, the systems disclosed further comprise a logic of showing the users' relationships to each other in the database. In some embodiments, the systems disclosed further comprise a logic to create or refine an archetype from search results. In some embodiments, the systems disclosed further comprise a search engine providing capability to search for things that relate to other users.

In some embodiments of this aspect, the items listed in the first user's profile appear as photo contact sheet and arranged in different categories. In some embodiments, the categories include hotels, bars, restaurants, and activities.

In another aspect are photo-based methods for content discovery and recommendation, comprising.
(a) creating a personal profile, or guidebook, based on inputs from a first user;
(b) storing the personal profile in a database;
(c) determining a degree of likes and preferences for each item listed in the first user's personal profile;
(d) showing the degree of likes and preferences in the first user's personal profile to a second user.

In some embodiments of this aspect, the methods disclosed are executable by a computer. In some embodiments of this aspect, the methods disclosed use internet for obtaining information of the items. In some embodiment of this aspect, the methods use a wireless connection to the internet. In some embodiment of this aspect, the methods use a wireless hand-held device.

In some embodiments, said database comprises a collection of pre-selected personal profiles. In some embodiments, said database comprises a collection of pre-selected items. In some embodiments, the items are selected from the group consisting of hotels, bars, restaurants, activities, and any combinations thereof. In some embodiments, the database comprises at least one pre-populated archetypes of profiles for a particular city, or area of interest or activity, such as opera or tennis, family travel or other hobby or activity group.

In some embodiments, the methods disclosed further comprise the step of showing the users' relationships to each other in the database. In some embodiments, the methods disclosed further comprise the step of creating or refining an archetype from search results. In some embodiments, the methods disclosed further comprise the step of allowing a user to use a search engine providing capability to search for things that relate to other users. In some embodiments, the methods disclosed further comprise the step of transferring the personal profile in the database into a storage facility.

In some embodiments of this aspect, the items listed in the first user's profile appear as photo contact sheet and arranged in different categories. In some embodiments, the categories include hotels, bars, restaurants, and activities.

In some embodiments, the systems or methods disclosed comprise a “Search Like” function enabling a user to change their search profiles to mimic another user. The systems or methods disclosed can generate recommendations, based in part, on a user's demographic profile and taste profile. By changing the search profile to mimic another user, the requestor can inherit that user's demographic and taste profile. For example, a middle-aged male in Denver could change his search request, to “search like a 25 year female in San Diego”. With this search request, the user can get a very different set of recommendations.

In some embodiments, the “Search Like” function of the systems or methods disclosed enables a user to search with the combined search profile of a group of users. For example, the user can request a search that combines the demographic and taste profiles of user1, user2, and user2's mother for the requested category (e.g. restaurant) in the requested locale (e.g. Boston). The search results can bring back recommendations that all three individuals would enjoy based on their collective tastes and preferences. For another further example based on the previous paragraph, there can be three personal profiles in the database according to the description “a 25 year female in San Diego,” and the systems or methods disclosed can enable the user to search recommended items based on one, two, or all three of these personal profiles.

In another aspect are photo-based content discovery and recommendation systems, executable by a computer, for internet users comprising:
(a) a database comprising a plurality of pre-selected personal profiles;
(b) a logic for determining a degree of likes and preferences for each item listed in the pre-selected personal profiles;
(c) a logic for enabling the users to perform internet searches based on the likes and preferences for at least one of the pre-selected personal profiles; and
(d) a logic for recommending items to the users based on the at least one of the pre-selected personal profiles.

In some embodiments of this aspect, the systems disclosed use internet for obtaining information of the items. In some embodiment of this aspect, the systems use a wireless connection to the internet. In some embodiment of this aspect, the systems comprise a wireless hand-held device for displaying said items.

In some embodiments of this aspect, the recommended items of step (d) are determined to be liked by all pre-selected personal profiles used in step (c). In some embodiments of this aspect, said database comprises a collection of pre-selected items. In some embodiments of this aspect,

In some embodiments of this aspect, the items are selected from the group consisting of hotels, bars, restaurants, activities, and any combinations thereof. In some embodiments of this aspect, the database comprises at least one pre-populated archetypes of profiles for a particular city.

In some embodiments of this aspect, the items appear as photo contact sheet and arranged in different categories. In some embodiments when the items appear as photo contact sheet, the categories include hotels, bars, restaurants, and activities.

In some embodiments of this aspect, the systems disclosed further comprise a logic of showing the users' relationships to each other in the database. In some embodiments of this aspect, the systems disclosed further comprise a logic to create or refine an archetype from search results. In some embodiments of this aspect, the systems disclosed further comprise a search engine providing capability to search for things that relate to other users.

In another aspect are photo-based methods for content discovery and recommendation, comprising,
(a) creating a plurality of pre-selected personal profiles;
(b) storing the pre-selected personal profiles in a database;
(c) determining a degree of likes and preferences for items listed in the pre-selected personal profiles;
(d) enabling an internet user to perform internet searches based on the likes and preferences for at least one of the pre-selected personal profiles; and
(e) recommending items to the users based on the at least one of the pre-selected personal profiles.

In some embodiments of this aspect, the methods disclosed are executable by a computer. In some embodiments of this aspect, the methods disclosed use internet for obtaining information of the items. In some embodiment of this aspect, the methods use a wireless connection to the internet. In some embodiment of this aspect, the methods use a wireless hand-held device.

In some embodiments of this aspect, the recommended items of step (e) are determined to be liked by all pre-selected personal profiles used in step (d). In some embodiments of this aspect, said database comprises a collection of pre-selected personal profiles. In some embodiments of this aspect, said database comprises a collection of pre-selected items. In some embodiments of this aspect, the items are selected from the group consisting of hotels, bars, restaurants, activities, and any combinations thereof. In some embodiments of this aspect, the database comprises at least one pre-populated archetypes of profiles for a particular city.

In some embodiments of this aspect, the items appear as photo contact sheet and arranged in different categories. In some embodiments when the items appear as photo contact sheet, the categories include hotels, bars, restaurants, and activities.

In some embodiments of this aspect, the methods disclosed further comprise the step of showing the users' relationships to each other in the database. In some embodiments of this aspect, the methods disclosed further comprise the step of creating or refining an archetype from search results.

In some embodiments of this aspect, the methods disclosed further comprise the step of allowing a user to use a search engine providing capability to search for things that relate to other users. In some embodiments of this aspect, the methods disclosed further comprise the step of transferring the personal profile in the database into a storage facility.

In some embodiments of any systems described above, the systems further comprise a wireless hand-held device for displaying said items. In some embodiments of any methods described above, the methods use a wireless hand-held device for displaying said items.

### INCORPORATION BY REFERENCE

All publications and patent applications mentioned in this specification are herein incorporated by reference to the same extent as if each individual publication or patent application was specifically and individually indicated to be incorporated by reference.

### BRIEF DESCRIPTION OF THE DRAWINGS

A better understanding of the features and advantages of the systems and methods provided will be obtained by reference to the following detailed description that sets forth illustrative embodiments and the accompanying drawings of which:

FIG. 1 shows an exemplary personal profile of the methods and system disclosed.

FIG. 2 shows an exemplary page showing hotels and bars of similar likes and preferences.

FIG. 3 shows recommendations created by the methods and systems disclosed.

FIG. 4 shows exemplary functions of the photo-based navigation of the methods and systems disclosed.

FIG. 5 shows additional functions of the photo-based navigation of the methods and systems disclosed.

FIG. 6 shows an exemplary function of an algorithm used by the methods and systems disclosed to weight connections to ratabables, other ratables, and other members.

FIG. 7 shows an example where a user can customize the items listed.

FIG. 8 shows an exemplary navigation pattern used by the methods and systems disclosed.

FIG. 9 shows an example for a user to obtain personalized recommendations.

FIG. 10 shows an example where two members' information are linked by the methods and systems disclosed.

FIG. 11 shows an example for adding additional item in a user's profile or list.

FIG. 12 shows an exemplary search engine of the methods and systems disclosed.

### DETAILED DESCRIPTION OF THE INVENTION

While certain embodiments have been provided and described herein, it will be really apparent to those skilled in the art that such embodiments are provided by way of example only. It should be understood that various alternatives to the embodiments described herein may be employed, and are part of the invention described herein.

Disclosed are mobile and online discovery engines for finding the people, places, activities, brands, goods and services that best match a user's exact preferences. A user may enter favorite things, places, and activities into the site and the disclosed methods and systems can discover what the user are most inclined to like based upon what others who share the same preferences most like. The results of searches can be displayed as part of an application or website on a personal computer, laptop or mobile device in a photo contact sheet format so the user can instantly decide if he or she wants to find out more based upon the image displayed. For mobile the results can be displayed in the iPhone's photo format, or a mobile version of the site. The predictive capacity of the methods and systems disclosed makes it easy to find recommendations and exact matches based on likes and preferences. For example, a user can find the hotels, restaurants, shops and shops that carry a certain brand of product in London preferred by friends or by people who like the same hotels, restaurants, and shops the user like in Montreal. The methods and systems disclosed provide a stronger, more precise, method of search and produce better results for certain searches such as travel and lifestyle brands.

The methods and systems disclosed provide highly accurate results to users of things that individuals who have similar affinity in their preferences of categories of hotels, activities, brands, restaurants . . . and the other categories also like by connecting things users like by their behavior on the site—clickstream search and navigation activity which can be either the default or an optional user defined enhancement for members and can be used to provide superior results for visitors to the site who the site has no personal information about—as well as the “rateables” or data items (such as a hotel or activity) in a member's guidebook or profile and then by using the site's affinity algorithms to identify the relevance of these items to other highly related items or rateables on the site and to present the highly related items to the users as new things they might like based on their indicated tastes and preferences on the site.

In some embodiments, the methods and systems disclosed comprise an algorithm and a Web site. The methods and systems disclosed provide a photo-based discovery site and application that uses the most precise information possible on how members (people who join the site and create profiles or guidebooks on the site) and visitors to the site (those who visit the site and use the site and its search functionality but do not create profiles or guidebooks on the site) want to be identified by as endorsing things by adding them to their profile or guidebook (for members only); viewing people, places and things on the site and through their behavior—such as their search patterns and clickstream or site navigation and site search activity on the site to identify relationships between people places and things.

In some embodiments, the site is a photo-based discovery site and is unique in this regard in that it is also a closed category site so that (1) photos are the primary navigation vehicle on the site (2) the site features a number of standard data fields or categories such as “hotels, activities, restaurants . . . ” this standard categorization is an important distinguishing feature of the site in that it (a) provides these categories with critical mass and thus more accurate relationships, affinity scores and recommendations (b) provides a superior user experience through more critical mass and more meaningful and accurate search results.

In some embodiments, the methods or systems disclosed comprises a search and discovery engine and a social networking site where members build their online profiles of things they like to do, events they plan on attending, places they like to go, their favorite things and brands from photos provided by members of the community that are tagged and coded with common metadata so photos, tags and pages can always be highly related to other photos for increased member engagement and satisfaction and to increase the percentage of the site's advertising inventory that can be sold at high CPM rates. These member, event and business profiles can look like composite photo sheets and give members viewing the profile of another individual, shop, hotel, brand, event such as an art gallery or museum exhibition opening, or other category, numerous photo choices of their favorite places, shops, hotels, restaurants, bars, activities and brands, they places they plan on being, events they plan on attending as well as the top friends of the individual and the of individuals who most closely match the member in their demographic and their likes. In some embodiments, as an individual viewing a profile page of a member or business, having numerous places to expand from when there is a profile match, will result in higher user engagement and higher page views which will in turn generate abnormally high advertising revenue for every visit, with no variable editorial cost for greater scalability and higher margins.

### LikeMe Algorithm

Behavioral discovery, such as navigation patterns, search patterns and how members interact with the site is used in the algorithm as either a default or an optional advanced setting that the site member can trigger to comprise part of the algorithm that provides affinity and resulting recommendations and results with similar affinity from actual site navigation and search data. This is a component of the algorithm that can be optional as the algorithm draws its results from a compilation of:

Site useage, navigation and search history—for members and visitors as outlined below
(a) in aggregate from all past collected clickstream, navigation and search history for members and visitors alike
(b) optional—in aggregate of members who share the same affinity scores
(c) optional—individual for members who use this feature for more precise results (this is an advanced user triggered setting that the company reserves the right to change into the default to present members with more precise results and to notify members of this change through the terms of service posted on the company's Web site www.likeme.net

Use of ratable or place data—such as photos or data objects placed in the guidebooks or profiles of members Ratable data is data objects and ratable data such are individual records with or without an image associated with them in the LikeMe Database. Individuals can add new ratable data which then become available for other members to add and use in their profiles as a data object used to determine affinity, recommendations and probability that users who like one item will like related items, which is the functionality of the site.
(a) in aggregate from all past collected clickstream, navigation and search history for members and visitors alike
(b) to further refine results—in aggregate of members who share the same affinity scores or same characteristics such as
   (i) membership in a “group” or “activity” on the site as indicated by electing to join a group or activity or filling in questions indicating membership in a demographic group—the site can include and overweight the groups preferences in the collaborative filtering, affinity algorithms if to get a more precise result
(c) on an individual basis the site can perform an enhancement to a k optimal pattern recognition algorithm in which an individual's driving factors—what results they are seeking, most interested in, most satisfied with—are uncovered by a variable combination of (1) the rateables of hotels, activities, restaurants and other date items they place in their profiles or guidebooks (2) their usage of the site in terms of navigation patterns, clickstream activity and search activity (3) how they fill in profile questions which can be used to determine additional relationships and correlations—since this is a derivation of a K Optimal Pattern Recognition algorithm which seeks to identify drivers of behavior and likes and dislikes for some individuals their answers to questions on demographic information and activities they like will be exceptionally predictive. For others, the rateables they assign and the order in which they assign them will be much more predictive with rateable data on the first page and furthest left assigned a progressively higher weighting than rateables data on subsequent pages of members guidebooks or to the right hand side of the page.

The LikeMe algorithm is a form of behavioral discovery using a matrix of behavioral discovery with stated preferences as indicated by the place data in a user's profile. So for example behavioral discovery is limited at the level of behavioral activities or stated preferences as results could be more accurate by adding user preferences and filtering on top of behavioral discovery so that results are delivered on an individual basis to users so they are more personalized and precise and take into account each individuals' stated preferences, likes and dislikes and prioritizes to deliver a more highly accurate, customized search result. This can be done by using a matrix of the users' profile or guidebook data (which is a parallel to members and visitors offline, real word experiences) with their site usage and with filtering questions ideally questions that ask for user preferences and not general or demographic questions that could then possibly be used with varying degree of error to project preferences instead of just asking for place data and preference questions.

LikeMe finds exactly what a member or visitors to the site is looking for by (1) using information from the member's profile of places and things that he or she like to recommend other places and things that members who like the same things also like. To do this the LikeMe Algorithm uses the metadata from the items the user has uploaded to his or her profile to find other items and members with the highest degree of relatedness as obtained from other members site profiles and site usage to recommend things to the member that have the highest relationship to those items on his profile and as obtained from his site usage. (2) Because members' profiles are in many instances public, are not anonymous, profiles with more “friends” and, or, connections in terms of how popular and highly related the places and things they have uploaded to their profile are to other people places and things on the site, these profiles and member activities with more critical mass will receive higher scoring on the LikeMe algorithm.

The algorithm on LikeMe scores affinity based on both members and rateables so members or rateables with more links to friends and things other members have rated showing higher affinity will have a multiplier over members or rateables that do not have the same high level of inter-related connections indicating a higher degree of connectedness to and influence on the community, thus having an optional multiplier score that can or cannot be used at the discretion of LikeMe to enhance or improve the user experience on LikeMe for members and visitors to the site.

Members can use the network to find other members who have the exact same favorite hotels, restaurants, shops, places to meet, parts of the city they frequent, brands, and recreational activities. This similarity of preferences, styles and standards gives members highly accurate, self-selecting results when they surf the network even in a passive manner to find things to do, things to buy, places to go and people to meet socially from those in the network who either have most similar taste and standards and, or, through searching just the results of their expanded social network for very precise matches.

The methods and systems disclosed can provide all categories matrix so if a user really likes an individual's hotel recommendations in Paris, the user can also see where she likes to dine, go out in the evening, shop and other preferences she can make public or private for others or just her friend and friends of friends to view and find in database search results.

Members can create their profile by clicking on or importing Web pages to the site's uploading interface to instantly and update visual profiles comprised of either thumbnails of or photos from the Web pages they click on to build their profiles showing their top choices in numerous categories in each city or for each activity or theme, such as country western, skiing, favorite things or family vacations, they build a profile for. Members can build profiles for multiple cities so they can use the site to find places to go and things to do in multiple cities, make connections in multiple cities and find recommendations of people, places and things that most closely align with their preferences and tastes in multiple cities. Methods and systems disclosed provide a very colorful and engaging online search and discovery social network comprised of people who share common interests in the same cities and are therefore best suited to recommend activities, venues, shops, brands and friends to others who share their taste and are looking to expand their activities, commerce or social networks in these areas.

The site can mix the best features of a social network with the offline word so that members can learn about places the people who they most like online go and the things they do and apply recommendations from their online word to their daily lives in the offline world. The network can be extendable to other cities and countries since members can for example search for hotels and nightlife in a city at the same time. So for example if a member lives in Boston and really likes the Four Seasons Hotel in Boston, the bar at Jury's hotel on Thursdays and dining at Aquitaine, he can search for matches that parallel these same bars, restaurants and nightlife but also expand to shops and people matches in San Diego, so that he has all of this information at his disposal for his trip and can for example select hotels in proximity to the shops, bars and restaurants he intends to visit and even contact locals who have connections to here network through people or places to get more information on local recommendations in San Diego before and while he is traveling and how he relates to these members and their favorite places and things to do in the city.

In some embodiments, the methods and systems disclosed allows a user to create or modify a profile or guidebook with photos and tags of the user's favorite friends in the network with the following information:

Friends in the network

Hotels—high advertising value pages

Restaurants

Places to meet (can be Bars and Nightclubs)

Places in the city (parts of the city, parks)

Brands

Shops

Activities

And an infinite number of member defined other categories and guidebooks

Reviews and Tags of 65 photo listings and any additional listings members want to create beyond these basic fields can be included on the second page of a member's online profile. This format also accomplishes the more important goal of providing members an online presence that is a reflection of their individual identity, so they are more likely to forward links to their profile page to their friends, often when their friends have purchase intent.

In some embodiments, the methods and systems disclosed have at least one of the following core features:
(a) Find recommendations and reviews of hotels, restaurants, bars, shopping and entertainment in the city you live in or are traveling to from individuals whose favorite hotels, places and things most closely match yours from a complete data set and/or who are in your one to six degrees of separation of chosen “friends” on the site.
(b) Find friends who share your exact interests, and in many cases, already frequent some of the same places you do and actually meet them at those places either through advanced planning or just say hi at the place or event if there is chemistry and they have proactively indicated they will be at the event
(c) Find new shops, restaurants brands and places recommended or tagged by those whose taste most closely matches yours. The more specific s user's taste is, the more elusive finding matches can be, so the more valuable the service will be for the user. For instance, if a user only wears specific brands of pants, shoes and shirts the user has developed a preference for one or two chains of contemporary furnished upscale hotels and have other very specific other preferences you are much more likely to value this network and to through conducting searches using the site, find other upscale minimal contemporary décor bars or restaurants, new hotels and clothing brands that you become a regular patron of through this service in addition to forming new relationships with those whose tastes in the areas of your preferences most closely aligns with your.
(c) Find new brands of clothing, mobile technology gadgets, home furnishings, anything people collect and actively seek to find new recommendation for quality harder to find things, places and activities that they will like.
(d) Build one or multiple personal, photo-based guidebook online.
(e) Find the businesses and people most closely associated with the businesses a user like the most, such as the restaurants that have the highest cross population of favorite bar or vice versa or where people who like the Prada brand of clothes for example are most likely to shop in a city that doesn't have a Prada store.

In some embodiments, the methods and systems disclosed provide at least one of the following advantages:
(a) Providing a quick and easy to build a visually compelling Web presence for members that members are proud of, that is something members will build identify upon and therefore forward on to others they meet in chat or on other Web sites, creating cost effective viral marketing for the site that results in exceptionally high growth.
(b) Sending members on highly satisfactory but infinite discovery loops of related information. By intentionally keeping users engaged through a mix of people and business photos and getting them to view more and more pages in a way that creates great degrees of user satisfaction.
(c) The site's personalization capabilities can make it the most highly targeted consumer media site on the market since users self select their favorite brands, hotels, restaurants and activities so advertisers can target members with an unprecedented degree of precision.
(d) The methods and systems disclosed can close the loop on the discovery process which also results in a higher multiplier of ad impressions and resulting revenue per session. With other Web sites and discovery applications, if you really like a member's recommendations on a hotel, bar, restaurant, music, brand of clothing or just their general aesthetic, you can only find related recommendations or information in instances where the member has populated it. So there is no way to for example to find a real profile of an individual, you are only presented with an aggregate of their recommendations or tags and they have no relational capabilities that would enable you to expand their recommendations to other categories or entries within the same category. Tagging and writing reviews is a very active process that fewer members will engage in than completing a profile of tags as part of a sign up process that rewards members by completing more information about their favorite hotels, restaurants, bars, shops, brands, activities places, cities, and other favorite things by providing more precise recommendations based upon how much of the profile the individuals self select. For example, your recommendations and matches become much more precise and powerful and you develop far more connections if you complete a complete profile rather than just listing a few favorites.

In some embodiments, the methods and systems disclosed provide at least one of the following features:
(a) Make it exceptionally easy for advertisers to micro-segment their audience for highest yields or brand lift;
(b) Make the first page of each user profile very standardized with little opportunity for members to add objectionable content as well as the site's ongoing manual review process on pages of the site sold through the direct sales force; and
(c) Having a data architecture in which data is continuously interrelated and standardized gives the methods and systems disclosed a huge competitive advantage over sites and other social networking site that are totally open ended and do not relate data well, making their recommendations and search results lower integrity and less valuable.

In some embodiments, the methods and systems disclosed require at least one of the following usability requirements:
(a) Fast loading of site (server side encode and file size limits) crucial for user experience because of all of the images/photos;
(b) Great graphics and compelling looking templates on the site;
(c) High integrity search results;
(d) Ability to auto import photos from the Web
(e) Flexible architecture for search parameters and privacy settings, i.e. show member photo or not.

Members can create guidebooks by (1) selecting the profile of a friend who has a profile on the site to customize (2) creating a profile from scratch by either uploading photos of the items they want in their profile or searching the site's database to upload this information.

For visitors who have not created guidebooks—they can search the site by either clicking on photos of members and businesses public profile pages to find correlations with other photos and data sets such as members and businesses or they can search by (1) finding a hotel restaurant, activity, bar or other business by searching for that category within a geographic area (2) searching for a restaurant, activity, bar, hotel or other business by searching for this entity through imputing one or more items the individual performing the search likes and wants to find an entry most similar to.

Members can navigate the site either through search or through clicking on photos on person, business or place profiles to go to the profile page of the photo and continue on a discovery loop. Members can use address book look up to use their email address book to find search results from a specific search of individuals in their email address book. For example, members can search for and find “New York hotel” recommendations of those in their address book that are displayed in search results with the email address of the person in their address book, the photo of the person if they have uploaded a photo to the site and the photo of the hotel(s) that individual recommends which they can then click on to go to the hotel's page. Because profiles are public or private only public profiles or profiles that the member has given the individual conducting the search access to will appear in the search results.

Members can make profiles public or private and even public to only individuals they specify. Private guidebooks are viewed as entirely separate records and do not impact search results of public profiles.

The way the site works is it relates the connections between photos and their corresponding metadata based on where the photos and metadata appear on the page, indicating the priority the individual has placed on the photo and corresponding metadata in association with its order on the page for listings in that category. So for example the individual's first hotel photo will have a higher weighting on search results than their fourth or than a hotel photo on the second page of their profile. This profile data is used to automatically make search results from an individual logged into the site more accurate and more customized to them.

Individuals can also chose to search multiple ways using all or part of the algorithm's predictive ability depending upon their personal preferences.

Photo based navigation and instant results of data relating to an object displayed by photos from the same and related categories is unique and novel to this site, so for example when a user finds a hotel he or she likes the hotel's profile page presents the user with photos of related hotels, activities, restaurants and other related businesses and the people who have photos to be displayed and have submitted positive reviews of the business.

The methods and systems disclosed can use the most precise information possible on how members and visitors to the site want to be identified by as endorsing things by adding them to their profile and view people, places and things on the site through their behavior on the site to identify relationships between people places and things.

The site can identifies behavior patterns based upon activities upon the site, and, or proxy this information from stated preferences in terms of a member's rateables, guidebooks and answers to guidebook and profile questions.

Behavioral discovery can be used by the site to provide more accurate search results

The methods and systems disclosed deliver a superior solution than behavioral discovery by using a matrix of behavioral discovery with stated preferences as indicated by the place data in a user's profile. So for example behavioral discovery is limited at the level of similar behavior by others without providing users filtering mechanisms so users are presented results of for example other purchases made by individuals who made a similar purchase. Results could be more accurate by adding user preferences and filtering on top of behavioral discovery so that results are delivered on an individual basis to users so they are more personalized and precise and take into account each individuals' stated preferences, likes and dislikes and prioritizes to deliver a more highly accurate, customized search result. This can be done by using a matrix of the users' profile data (which is a parallel to what users “bought” or “listened to”) with their site usage and with filtering questions ideally questions that ask for user preferences and not general or demographic questions that could then possibly be used with varying degree of error to project preferences instead of just asking for place data and preference questions.

In some embodiments, the methods and systems disclosed are much more accurate that search engines for finding exactly what a member or visitors to the site is looking for by (1) using information from the member's guidebooks of places and things that he or she like to recommend other places and things that members who like the same things also like. To do this methods and systems disclosed use the metadata from the items the user has uploaded to his or her profile to find other items and members with the highest degree of relatedness as obtained from other members site profiles and site usage to recommend things to the member that have the highest relationship to those items on his or her guidebooks and as obtained from his site usage. (2) Because members' profiles are public, are not anonymous and members profiles with more “friends” and, or, connections in terms of how popular and highly related the places and things they have uploaded to their profile are to other people places and things on the site, these profiles and member activities with more critical mass will receive higher scoring on the methods and systems disclosed.

In some embodiments, the methods and systems disclosed work so that people's profiles with more links to friends and things other members have rated showing higher affinity will have a multiplier over user or business profiles that do not have the same degree of connectedness to and influence on the community.

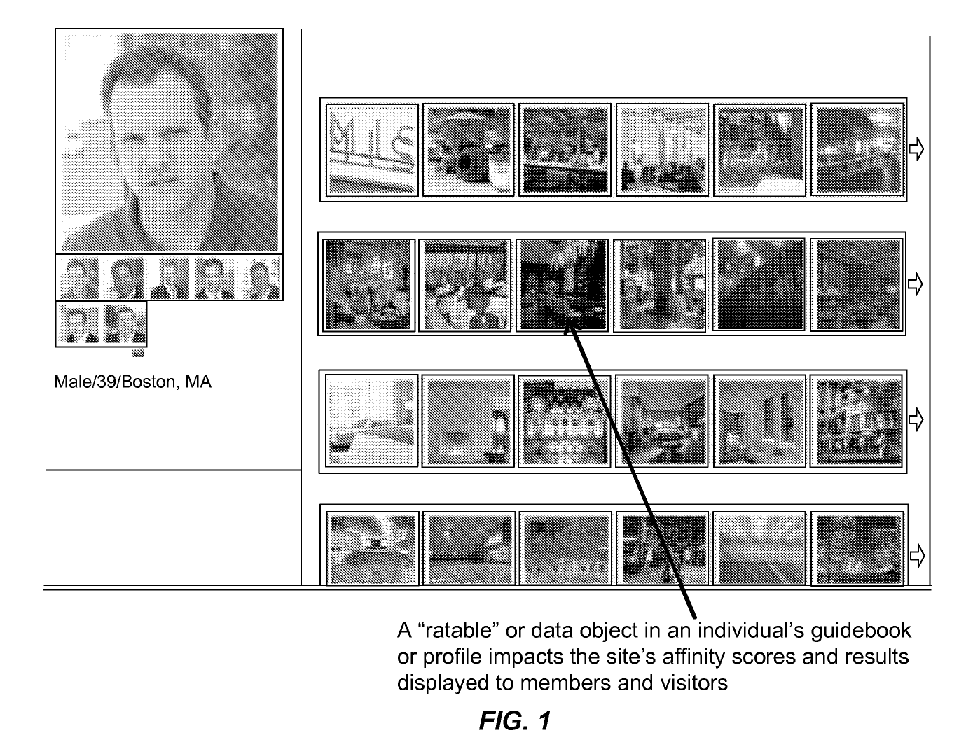

FIG. 1 shows an exemplary personal profile of the methods and system disclosed. A “ratable” or data object in an individual's guidebook or profile impacts the site's affinity scores and results displayed to members and visitors.

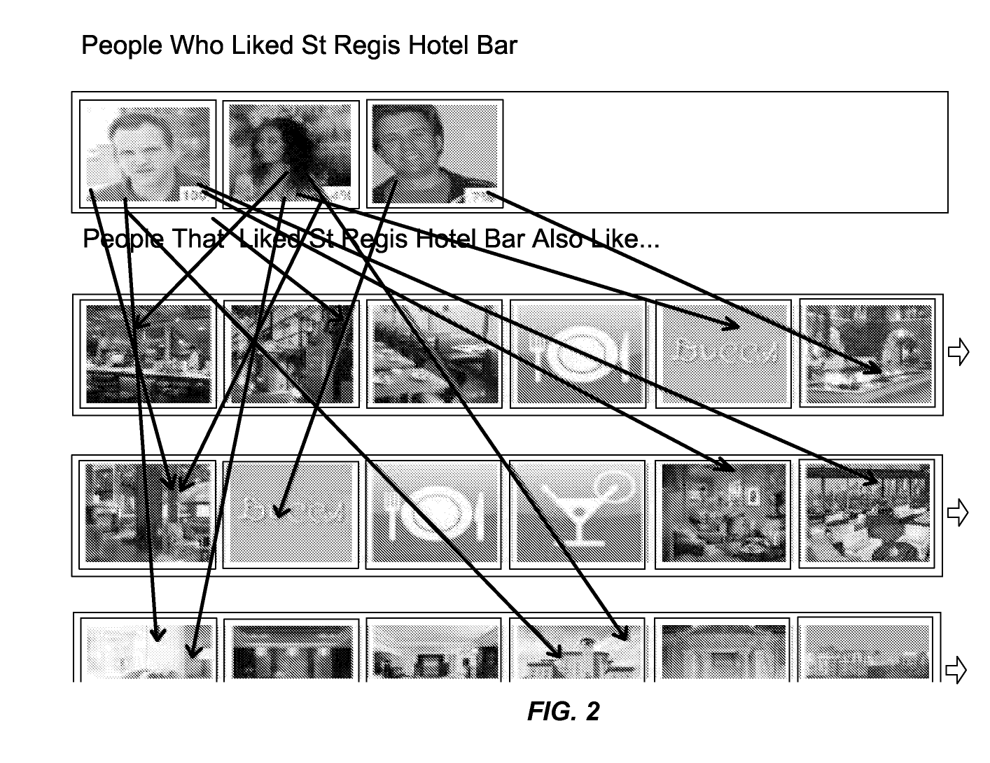

FIG. 2 shows an exemplary page showing hotels and bars of similar likes and preferences. People who like also like is a compilation, scoring and ordinal ranking of the affinity scores of rateables by categories with the highest scores being presented to the left—people's other rateables is just one of the factors contributing to this score as described.

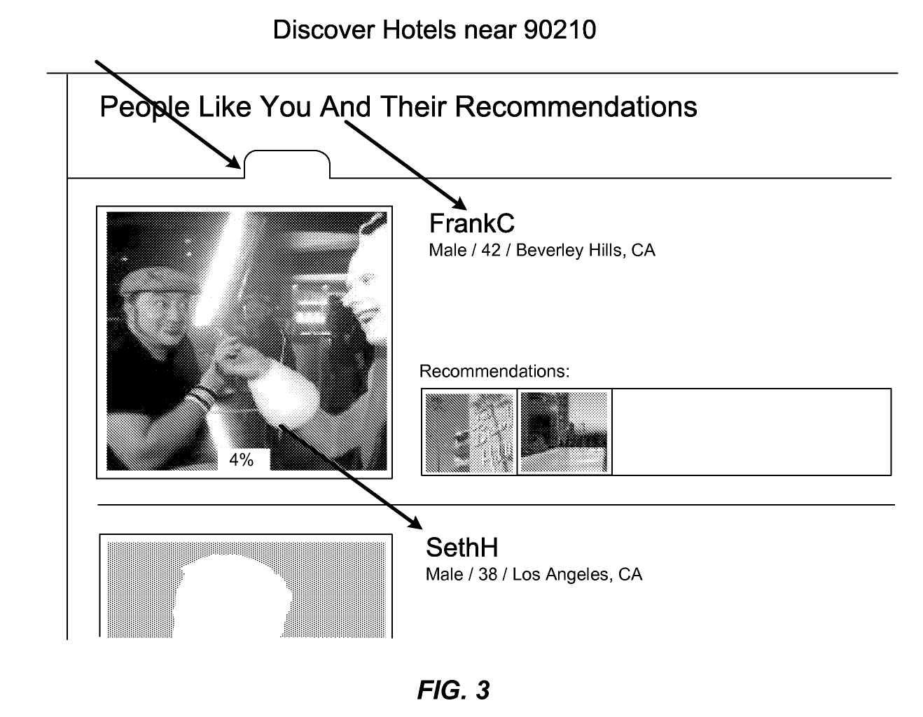

FIG. 3 shows recommendations created by the methods and systems disclosed. Members and visitors can view search results of rateables such as hotels by rateable, i.e. by hotel or by people as in this example, showing recommendations fitting the search criteria ordered by people with highest affinity being presented first.

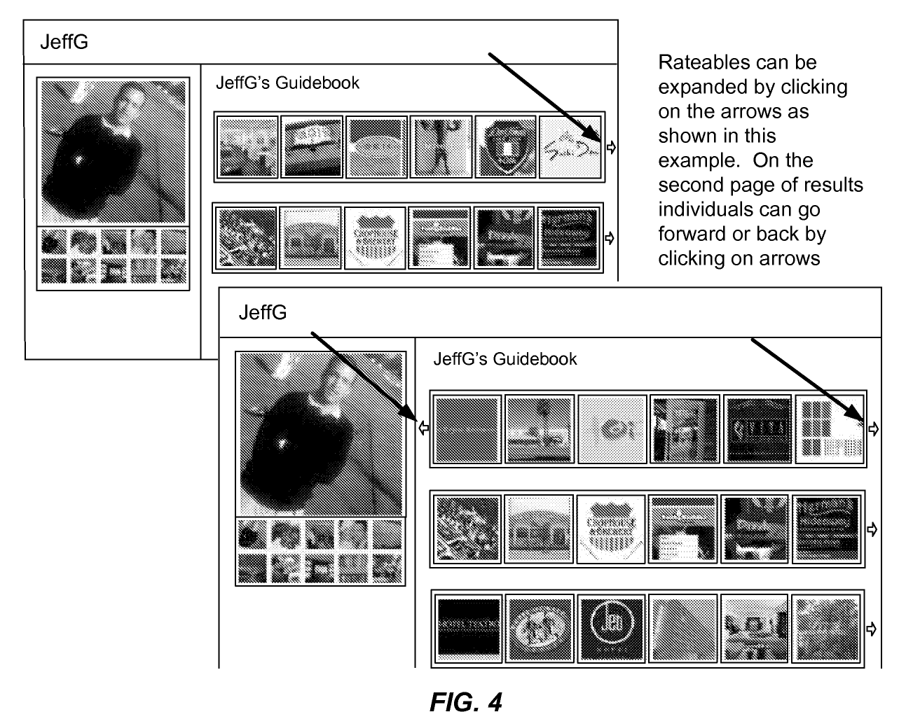

FIG. 4 shows exemplary functions of the photo-based navigation of the methods and systems disclosed. Rateables can be expanded by clicking on the arrows as shown in this example. On the second page of results individuals can go forward or back by clicking on arrows.

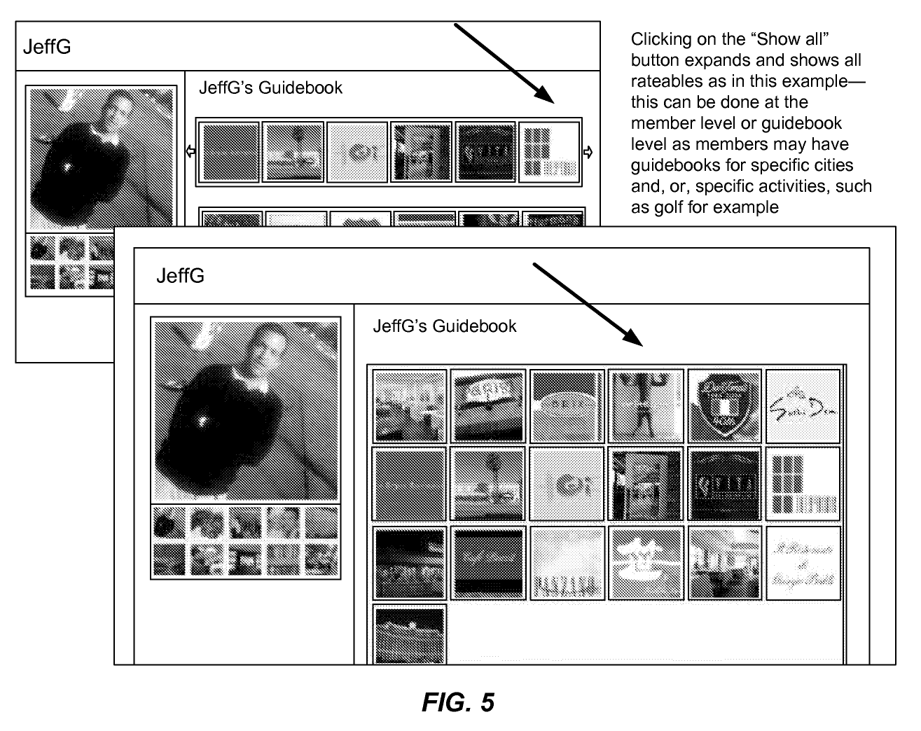

FIG. 5 shows additional functions of the photo-based navigation of the methods and systems disclosed. Clicking on the “Show all” button expands and shows all rateables as in this example—this can be done at the member level or guidebook level as members may have guidebooks for specific cities and, or, specific activities, including golf for example.

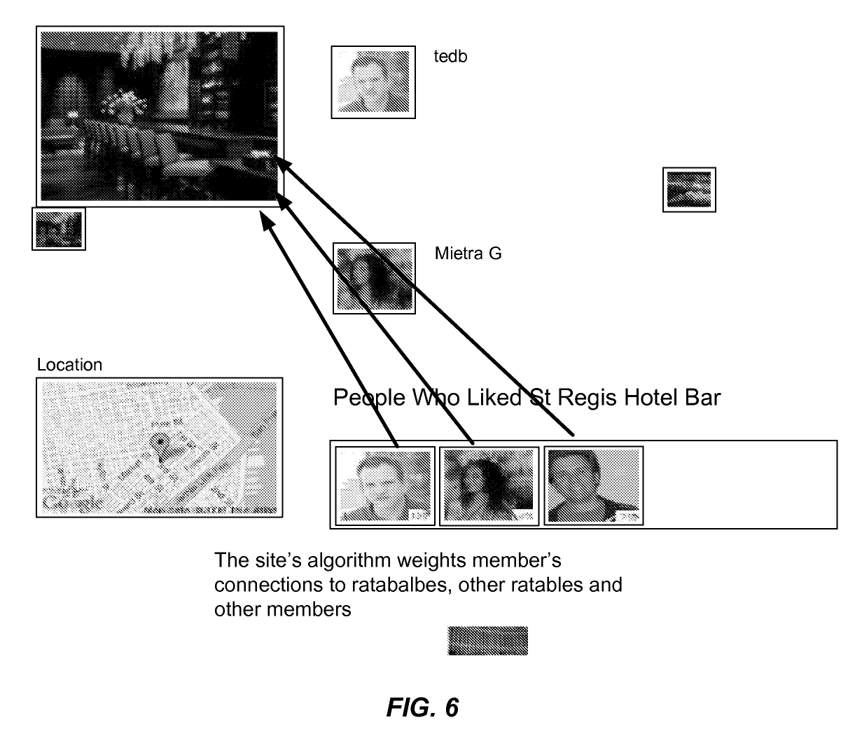

FIG. 6 shows an exemplary function of an algorithm used by the methods and systems disclosed to weight connections to rateables, other ratables, and other members.

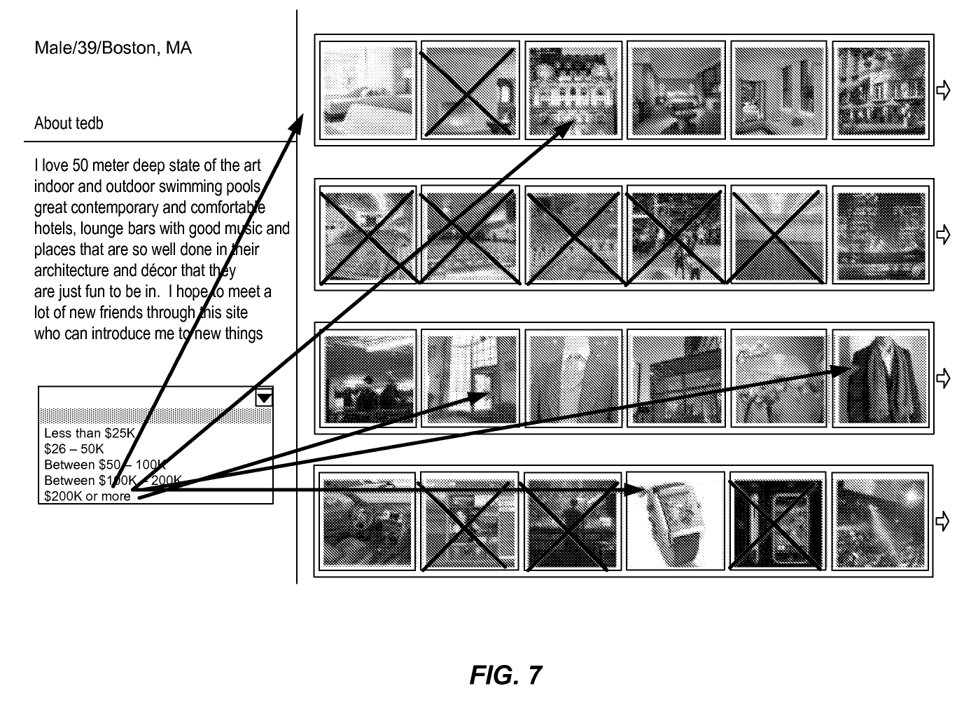

FIG. 7 shows an example where a user can customize the items listed. Questions can be used to present more precise results when questions and, or, specific answers are found to have a high correlation to rateables such as in this example, an arrow indicates a very high correlation, an x through a rateable indicates a very low correlation. High correlations can be used by the algorithm and questions and answers can provide data bridges when the site lacks rateables data to for example connect stores patronized by those with $200 k+ income in one city to stores patronized by $200 k+ income in another city where there is no rateable connection or to strengthen a rateables connection.

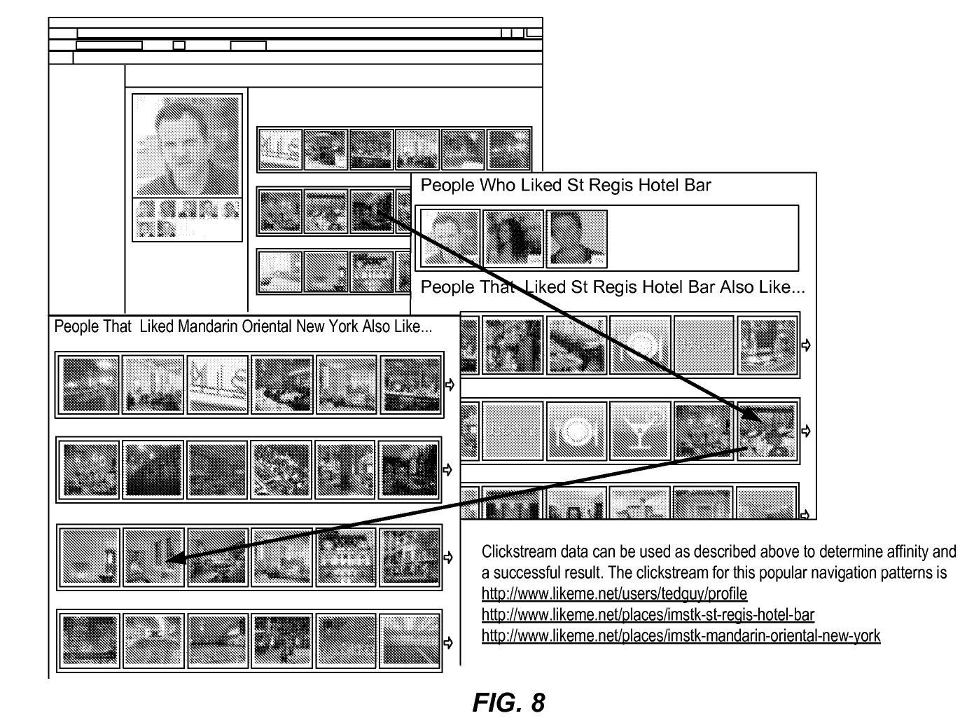

FIG. 8 shows an exemplary navigation pattern used by the methods and systems disclosed. Behavioral date in the form of site usage patterns, such as navigation and search patterns and clickstreams can also be used in the aggregate from members and visitors to determine affinity for members, visitors or members during a session as well as groups indicated by a members friends or their answers to questions, such as activities and demographic questions. The algorithm has the capability to draw from this information and since it is a self learning, smart algorithm, dynamically and consistently refine results based on behavioral data on the site indicating a successful result such as members adding an item to their guidebook.

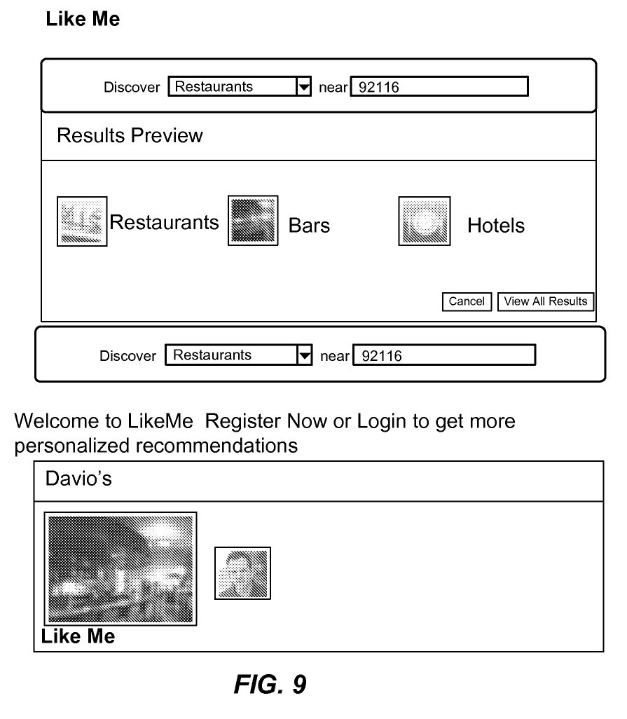

FIG. 9 shows an example for a user to obtain personalized recommendations. The algorithm learns affinity from site usage. For example, when a member is logged in a member adding a rateable to their guidebook shows high affinity, similar answers to questions, which can serve as data bridges can also indicate high affinity in many instances as can similar search and behavioral patterns on the site. For example visitors taking an action—such as registering for the site—after being presented with a search result can be used as data affirming the result was satisfactory. Adding a rateable to a member guidebook or a person as a friend also indicates affinity and a satisfactory search result or navigation pattern.

Taking multiple session level navigation and search patterns from site visitors as well as navigation and search patterns from logged in members can be used any of the following ways to provide a superior user experience:

Session level clickstream information and/or aggregated clickstream information can be used to refine the results of visitors to the site not logged in by incorporating navigation patterns, affinity scores and other data into the ordering of their search results and how information is presented to them based on what we know about them—which is their geolocation and their IP, since we have no affinity from these visitors we can use the affinity of others in the same geolocations and with the same IP providers to provide enhanced search results

Clickstream data of members logged in can be used to present a superior search result and user experience. These settings are triggered in accordance with the site's terms of service and enable LIkeMe to present more relevant results and a superior user experience to members

Potential uses of clickstream data are:
(a) Aggregated
(b) For member
(c) For geolocation and IP as described above for visitor and also potentially weighted for members if it is providing a strong result
(d) For members “friends” on the site
(e) For groups as selected by answers to questions, such as demographics and activities
(f) For members and visitors with very high affinity in certain ratables such as “restaurants” or types of restaurants when they are navigating or searching restaurants.

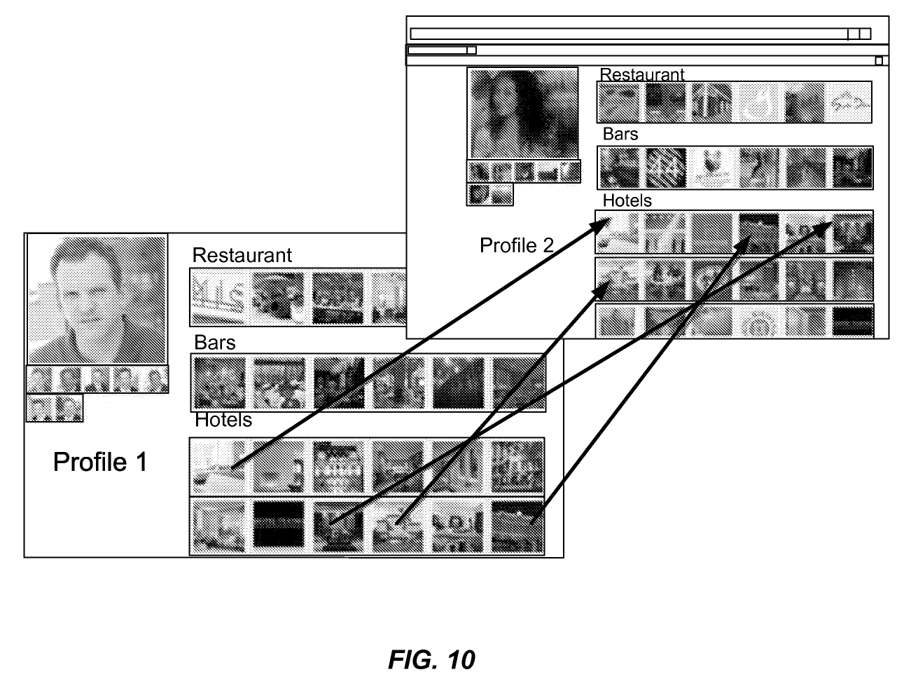

FIG. 10 shows an example where two members' information are linked by the methods and systems disclosed. These two LikeMe members MietraG and TedB live in different cities and have different activities so their overall affinity score is not that high, however they are “friends” on the site and share a high number of common “friends” on the site as well as having very high correlation of hotel s worldwide, but particularly in San Francisco and Denver. Both have listed as their highest rated and highest scored hotel the St. Regis in San Francisco so the algorithm is able to recognize and overweight their affinity for hotels and specifically hotels in Denver and San Francisco.

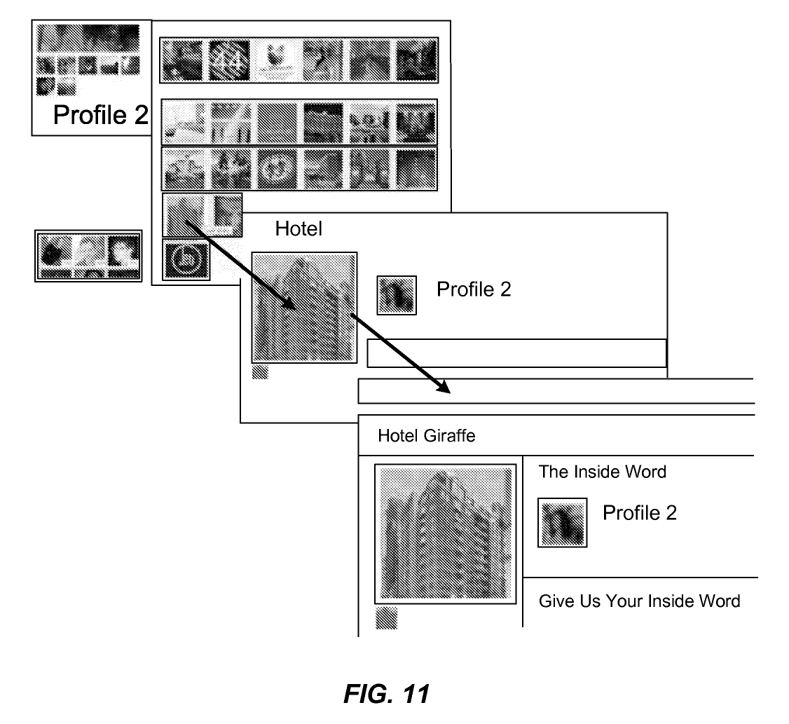

FIG. 11 shows an example for adding additional item in a user's profile or list. In this example, LikeMe member TedB who has high affinity in hotel to MietraG had a navigation pattern of going to MietraG's guidebook, viewing the hotel category of rateables in which he had high corrlation, clicking on a hotel and adding the hotel to his “to do” list on this site, this clickstream data can be used to enhance correlations and present superior affinity, also since adding the hotel to the “to do” list indicated a positive outcome correlations and affinity scores are strengthened as a result and can be further strengthened with a multiplier to further weight this area of high and multiple correlations.

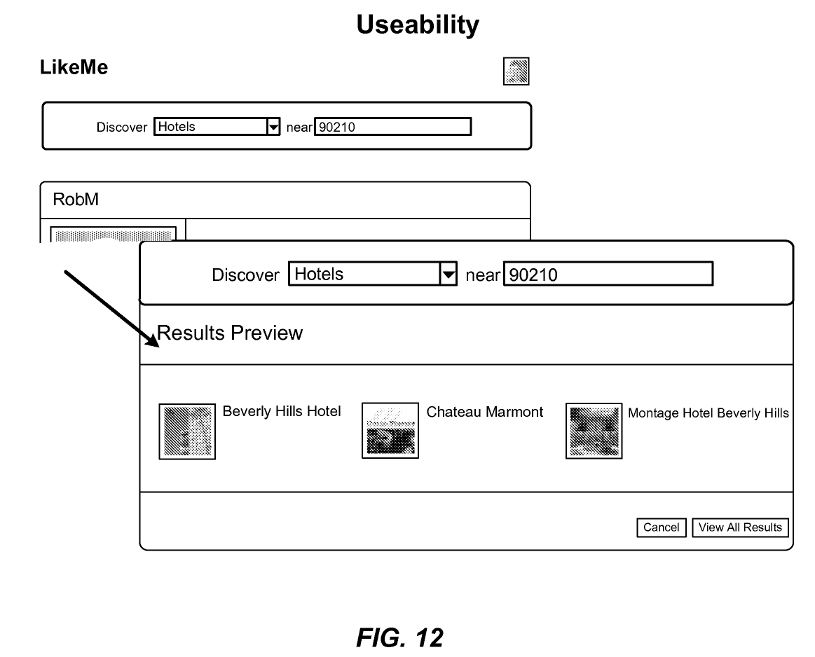

FIG. 12 shows an exemplary search engine of the methods and systems disclosed. The site's drop down box which is triggered by search result is unique in that it appears after a search is triggered and can be expanded as in the example below.

It will be understood by those of skill in the art that numerous and various modifications can be made without departing from the spirit of the present invention. Therefore, it should be clearly understood that the forms of the present invention are illustrative only and are not intended to limit the scope of the present invention.

The invention is described in greater detail by the following non-limiting examples.

### EXAMPLE 1

### Scoring from Profile or Guidebook Member Rateables and Friend Data

Members of the site may have Guidebooks on a city and activity level. So for example you can just have one guidebook, or profile, or multiple guidebooks for each city and activity you chose to compose a guidebook for, such as: Mietra's Guidebook (includes everything, all of Mietra's ratables (images and data records for the items in LikeMe categories such as hotels, restaurants, activities, or user defined categories such as “tennis”, “antiquing”), Mietra's Guidebook for Tampa (only includes rateables—image and place data from Tampa) and Mietra's Guidebook for Swimming or Mietra's Guidebook for Opera (only includes rateables—image and place data for those activities).

The Algorithm for LikeMe is a base algorithm for the entire site as well as customized algorithms for each member, visitor and group which are customized to find each member, visitor or group's K Optimial Patterns in terms of preferences of rateables and members of the site as well as their user experience on the site. Like other sites with complex algorithms the algorithm will be tuned to ensure data result integrity but its base methodology of getting results for search results, affinity scores and recommendations will stay a combination of:
1) Members use of rateable data and it's inter-relationships to other rateable data and members on the site as added to their guidebooks for members. For members and visitors alike this data will be aggregated and affinity scores derived from it to present high integrity results when members and not logged in and for visitors to the site.
2) Use of demographic, psychographic, affinity, activity and group question data to connect individuals who answer questions in similar or related manners to rateables that correlate very highly to those same combinations
3) Site usage, navigation patterns and their relationship to rateables or other data proxies that correlate very highly to rateables as determined by site useage and search activity. For example individuals who always click on certain rateables, such as hotels with a very high affinity score for those and other hotels and restaurants and activities are presented with the results that others with similar site usage and, or, who have those rateables in their guidebooks or profile have.

To get the best result for the users of the site based upon the information the site has from users. Of the information the site has to pull from relationships and similarity or relatedness of place data within profiles of users on the site listed in Table 1. If there are very high correlations of relatedness between one place and another place on users' profiles this would indicate that individuals who like one place are likely to like the other and that the 2^{nd} place should be presented in search results, on the profile of the second and as a recommended place for people who like the first.

TABLE 1

| | | |
|---|---|---|
| High % correlation between 2 | Multiplier for example 1.1 | Individual scoring, for |
| places on multiple users | | example business place data |
| profiles | | records on the first page of |
| | | multiple users' profiles could |
| | | get scores between 1-5 with |
| | | the higher score going to the |
| | | data more prominently |
| | | displayed on the members' |
| | | profile - i.e. the first slot on |
| | | the right on the top page |
| High % correlation between 2 | Higher multiplier, for example 1.3 | Individual scoring, for |
| or more places on multiple | | example business place data |
| users profiles | | records on the first page of |
| High % correlation between | | multiple users' profiles could |
| the users listing the places on | | get scores between 1-5 with |
| their profiles as well as | | the higher score going to the |
| measured by the other things | | data more prominently |
| on their profile | | displayed on the members' |
| | | profile - i.e. the first slot on |
| | | the left on the top page |
| High % correlation between | Higher multiplier, for example 1.5 | Individual scoring and a |
| the 2 or more places on | | higher multiplier assigned to |
| multiple users profiles | | business place data common |
| High % correlation between | | to multiple users that is |
| the users | | positioned prominently on the |
| High % correlation between | | users profiles, i.e. the first slot |
| the profiles of the businesses | | on the left of the top page and |
| common to the users | | high similar positioning on |
| | | common business profiles due |
| | | to the high inter relationships |
| High % correlation between | Higher multiplier, for example 1.75 | Individual scoring and a |
| the 2 or more places on | | higher multiplier assigned to |
| multiple users profiles | | business place data common |
| High % correlation between | | to multiple users that is |
| the users | | positioned prominently on the |
| High % correlation between | | users profiles, i.e. the first slot |
| the profiles of the businesses | | on the left of the top page and |
| common to the users | | high similar positioning on |
| High % correlation between | | common business profiles due |
| the site activities and selected | | to the high inter relationships |
| search results of common | | as well as high correlations of |
| users | | similar searches as a |
| | | percentage of overall web site |
| | | activity by the users when |
| | | logged into the site |
| High % correlation between | Higher multiplier, for example 1.9 | Individual scoring and a |
| the 2 or more places on | | higher multiplier assigned to |
| multiple users profiles | | business place data common |
| High % correlation between | | to multiple users that is |
| the users | | positioned prominently on the |
| High % correlation between | | users profiles, i.e. the first slot |
| the profiles of the businesses | | on the left of the top page and |
| common to the users | | high similar positioning on |
| High % correlation between | | common business profiles due |
| the site activities and selected | | to the high inter relationships |
| search results of common | | as well as high correlations of |
| users | | similar searches as a |
| High % correlation between | | percentage of overall web site |
| the questions or search criteria | | activity by the users when |
| individuals filled in on their | | logged as well as high |
| profiles and the relationship | | correlations between profile |
| between these answers or | | questions and, or, search |
| search criteria and common | | preferences |
| results | | |

### EXAMPLE 2

### Getting Data into the Algorithm Fast and the Evolution of the Algorithm

The algorithm logic can start as outlined in the first row of the table with simple scores just looking at the % match between place data records—such as restaurants—to rank which restaurant records to present as most related in:

(a) search results such as “show me restaurants in san Francisco like the Ivy”;

(b) business profiles as a neighbor of other business; and

(c) thing you might like data feed on your logged in home page

If the below is a member's profile with the rows different categories such as restaurants in row 1 of Table 2, hotels in row 2 and so on, below is an example of how profiles can be scored. The highest total scores in terms of the things that also have one business or person having an other are represented as points 1, 2 and 3 above, in search results, in business profiles as neighbors or “businesses people who liked also liked” or things you might like in your logged in home page.

TABLE 2

| | | | | | |
|---|---|---|---|---|---|
| 5 | 4 | 3 | 2 | 1 | 1 for every entry |
| | | | | | on subsequent |
| | | | | | pages |
| 5 | 4 | 3 | 2 | 1 | 1 for every entry |
| | | | | | on subsequent |
| | | | | | pages |

The math would then look like this for example: Highest common scores with Ivy restaurant

AME restaurant 88.7

Café Annie 82.3

Lennox 79.1

This weighting could have anywhere from 100% of the math weighting on the site to a much lower percentage depending on how good a predictor other data from the site such as:
Other potential sources for the algorithm to pull data:

### EXAMPLE 3

### Scoring from Site Usage

Site usage=search query strings, instances where multiple people performed the same searches, for example “show me restaurants in san Francisco like the Ivy in Santa Monica” and selected the same results—site usage could over time account for the highest percentage of the algorithm and will be the most frequently and dynamically updated portion of the algorithm, so ideally as the site grows this data will batch, refresh, with increasing frequency to make the system more real time.

The math behind site usage could work the following way: For businesses, it can find the business in all click stream and search query string data.

For people, when they are logged in the algorithm can pull site activity such as click stream and search query data to learn more about the people and personalize the results.

For businesses and people:
www.likeme.net/findlike/ivy/boston/restaurant
www.likeme.net/findlike/ivy/boston/restaurant/results
www.likeme.net/banq/boston-restaurant
www.likeme.net/findlike/ivy/boston/restaurant/results
www.likeme.net/mistral/boston-restuarant
www.likeme.net/forward-to-a-friend/mistral/boston-restuarant
www.likeme.net/forward-to-a-friend/banq/boston-restuarant
www.likeme.net/wishlist/mistral/boston-restuarant

In this example we could divide all restaurant activity by the total number of page views of restaurants in sessions and search activity. Search activity could have a 2× to as high as a 10× value to session activity (more passive discovery) or even be the only parameter used if it proves to be the most telling in terms of individuals' preferences. In the example above the algorithm math would be as follows:
8 pages of total activity to score from as per below
   www.likeme.net/findlike/ivy/boston/restaurant-100 score-using Ivy as what he wants
   www.likeme.net/findlike/ivy/boston/restaurant/results
   www.likeme.net/banq/boston-restaurant
5 point affinity score between Banq Boston and Ivy Santa Monica—indicating potential affinity as search result clicked on
   www.likeme.net/findlike/ivy/boston/restaurant/results
   www.likeme.net/mistral/boston-restuarant
5 point affinity score between Mistral Boston and Ivy Santa Monica—indicating potential affinity as search result clicked on
   www.likeme.net/forward-to-a-friend/mistral/boston-restuarant
15 point affinity score between Mistral Boston and Ivy Santa Monica—indicating potential affinity as search result clicked on then forwarded to a friend
   www.likeme.net/forward-to-a-friend/banq/boston-restuarant
15 point affinity score between Banq Boston and Ivy Santa Monica—indicating potential affinity as search result clicked on then forwarded to a friend
   www.likeme.net/wishlist/mistral/boston-restuarant
25 point affinity score between Banq Boston and Ivy Santa Monica—indicating potential affinity as search result clicked on then wishlisted

Then . . . Days later . . . 3 more pages to also score from
www.likeme.net/wishlist/mistrallboston-restuarant/add-restaurant-boston
50 point affinity score between Banq Boston and Ivy Santa Monica—indicating affinity as search result clicked on, forwarded to a friend, wishlisted than added to profile
www.likeme.net/wishlist/mistral/boston-restuarant/add-restuarant-boston/inside-word
75 point affinity score between Banq Boston and Ivy Santa Monica—indicating affinity as search result clicked on, forwarded to a friend, wishlisted than added to profile with an inside word

Friend's LikeMe page
www.likeme.net/wishlist/mistral/boston-restuarant/add-restaurant-boston
10 point affinity score between Banq Boston and Ivy Santa Monica—indicating affinity as search result clicked on, forwarded to a friend, wishlisted than added to profile
www.likeme.net/wishlist/mistral/boston-restuarant/add-restuarant-boston/wishlist
15 point affinity score between Banq Boston and Ivy Santa Monica—indicating affinity as search result clicked on, forwarded to a friend, wishlisted than added to profile with an inside word

Total affinity scores:

| | |
|---|---|
| Ivy and Banq | 20 |
| Ivy and Mistral | 195 |
| Mistral Boston and Banq | (195 + 20)/2*2 = 54 |
| Person A and Ivy | 295 |
| Person A and Mistral | 20 |
| Person A and Banq | 195 |
| Person A and Person B | 165 |
| Person B and Person A | 165 |
| Person B and Ivy | (100/2) = 50 |
| Person B and Banq | (20/2) = 10 |
| Berson B and Mistral | (50 + 75 + 15) = 115 |
| Person A and all of Person B's | if full set is Ivy and Banq |
| restaurants | it's the total score of |
| | (295 + 20 + 195 + 165 + |
| | 50 + 10 + 115) = |
| | 830/# of objects 5 = |
| | (830/5) = 166 |

For visitors to the site, LikeMe can detect their IP address and their geolocation and provide them search results ordered by those with similar geolocations and IP addresses for more accurate results.

### EXAMPLE 4

### Scoring from Questions During the Sign Up Process

Some questions asked and answered during the sign up process can be excellent predictors of what people do and don't like and give users 100s of more ways to search by using just the questions that are most specific to them so users can essentially tune and customize a discovery algorithm by overweighting search criteria in the form of customized questions and search criteria of high relevance to them.

Questions in the form of customized search criteria could be used as accelerator multipliers, so for example, if we have demographic information of individuals and find that greater than 80% of a business' clientele are a certain age and income, the algorithm's weighting of questions could shift from whatever percentage it is set at to perhaps 60% to 80% for the questions that indicate people in this group are most likely to like a place. It's important for questions not to account for too high a percentage of the algorithm as there will always for example be girls dating more affluent guys who would not on their own income score high enough to like a place based on questions but if you looked at their place data in their profiles and their site activity, they would score high and the results present recommendations they would like. This is why questions can only be used on an individual basis and after they are found to be predictive.

Here some practical examples of how questions can be used:

TABLE 3

| | | | | | | Zip | | | |
|---|---|---|---|---|---|---|---|---|---|
| | Age | Sex | Race | Kids | Single | Code | Seeking | Income | Taste |
| Trendy | 70% | na | 90% | 80% | 60% | 75% | na | 95% | 80% |
| restaurant | 30-50 | | (90% | no | (60% | | | (restaurant's | |
| | (50% | | of site | Kids | of site | | | income is in | |
| | of site) | | is | (75% | is | | | top 30% of | |
| | | | white) | of | single) | | | site) | |
| | | | | site | | | | | |
| | | | | has | | | | | |
| | | | | no | | | | | |
| | | | | kids) | | | | | |
| Upscale | 70% | na | 95% | na | na | 60% in | na | na | 80% |
| Hotel | 35-60 | | (90% | | | affluent | | (hotel's | |
| | (50% | | of site | | | Zip | | income is in | |
| | of site) | | is | | | codes | | top 20% of | |
| | | | white) | | | | | site) | |
| Upscale | 70% | 95% | 90% | na | na | na | 90% | na | na |
| Gentle | 30-50 | (40% | (90% | | | | (<5% of | | |
| men's | (50% | of site) | of site | | | | site is | | |
| bar | of site) | | is | | | | men | | |
| | | | white) | | | | seeking | | |
| | | | | | | | much | | |
| | | | | | | | younger | | |
| | | | | | | | women) | | |
| Ethnic | 80% | 95% | 02% | 85% | 70% | 70% | 90% | na | na |
| bar | 21-35 | (60% | (90% | no | (60% | | (<5% of | (bar's | |
| | (45% | of site) | of site | (75% | of site | | site is of | income is in | |
| | of site) | | is | of | is | | that | middle 50% | |
| | | | white) | site | single) | | ethnicity) | of site) | |
| | | | | has | | | | | |
| | | | | no | | | | | |
| | | | | kids) | | | | | |
| Hyatt | na | na | na | na | na | na | na | (hotel's | na |
| Hotel | | | | | | | | income is | |
| | | | | | | | | bottom | |
| | | | | | | | | 40%) | |
| Indi | na | na | 80% | 80% | 65% | 80% | na | 80% | 70% |
| Coffee | | | (90% | no | (60% | local | | | |
| shop | | | of site | (75% | of site | | | | |
| | | | is | of | is | | | | |
| | | | white) | site | single) | | | | |
| | | | | has | | | | | |
| | | | | no | | | | | |
| | | | | kids) | | | | | |
| Ivy | 70% | na | 78% | na | na | 80% in | na | 70% | 80% |
| restaurant | 30-60 | | white | | | affluent | | (Ivy's | |
| | (53% | | 20% | | | zip | | income is | |
| | of site | | Black | | | codes | | top 20% of | |
| | | | (90% | | | or local | | site) | |
| | | | of site) | | | | | | |
| | | | is | | | | | | |
| | | | which | | | | | | |
| | | | 5% of | | | | | | |
| | | | site is | | | | | | |
| | | | black) | | | | | | |

From the above questions and the percentages of the site, strong affinity or likeness indicators of one or more questions how individual questions, like Tags or Tag Words could be powerful predictors of affinity.

It is important to see not only what % of people who answer questions certain ways are friends of a business or have place or site activity data relating to a business but how that percentage interacts with the site overall. For example with Ivy restaurant if the site is comprised of 90% white individuals and Ivy is patronized by 78% white individuals and 20% black individuals it may have a higher black following than other businesses but only from black people of a certain age, income and living in a certain zip code. Ideally giving users the ability to search tags puts them in control and enables them to take ownership for their search results.

For a trendy restaurant, an independent coffee shop or an upscale hotel, if there is a high variance between the number of individuals on the site with certain characteristics in their profile, such as their zip code, ethnicity, age, income and a place. Taking all of these features and multiplying the individual variances to create question and question category scores and bumping up the percentage questions account for the algorithm would be a good way to test how the use of questions or tags could assist the algorithm in presenting results. Below are some examples:

Individual A=Male 50, black, income over $500 k/yr, lives in Ivy restaurant zip code, has kids, married
Ivy scores:
Age—no major variation from standard scores of site and restaurant no math
Sex—no major variation from standard scores of site and restaurant no math
Race—blacks are 5% of site and 20% of Ivy's customers—50 points
Kids, Single, Seeking—no major variation from standard scores of site and restaurant no math
Income—20 point variation with site average—20 points
Zip code—20 points for living in the same zip code as business—20 points
Taste—20 points
Total question score 110

The algorithm can dynamically weight it's 4 inputs (1) rateables or place data including members “friends” or member data records (2) site usage (3) answers to questions in a weighting that dynamically adjusts and can be adjusted at any time for the best results, so the algorithm may use 90+% rateables data at one time or for one member or during one visitor session and use other combinations with less a lower percentage assigned to rateables or place data at another time. If the algorithm uses the following percentages to calculate the total score:

Rateables or Place data 45%

Site usage, navigation and search activity 45%

Questions when applicable 10% (i.e in some instances question are not applicable so this would be a 0 score if the site were using this fixed weighting of the data buckets it has to draw from at this time and the above categories move to 50% each)

For question scores of for example greater than 100, applicable questions in this case race, taste, zip code and income, could collectively account for 20% of the algorithm and place data and site data would account for the other 80%. If there was no place or site data, applicable questions would account for 100%.

### EXAMPLE 5

### Data Bridges and the Algorithm

In the event we only know place data, site activity data or questions or some combination of the three as per above we can use the information we have to present search results, affinity and recommendations to people.

For individuals not logged in or those we know little to nothing about we can present results based on the highest affinity scores with the information we do know about them. For example if we only know their zip code from geo-location or from their answering questions we can show them search results or recommendations that have the highest affinity scores across place data, site activity and questions.

So for example for a non logged in users searching restaurant in Boston, we would just display the restaurants that have the most profile and site use data scores—a combination of the two methods above. For a new member who has completed his place data and questions but has not used the site we would rely more on the place data and questions in the example above, so for example place data if fully filled in would be 80% of search results and questions 20%. These percentages could be moved up or down as we get more data in and determine their validity. If an individual fills in 100% profile place data but answers no questions place data would become 100% if the individual just fills in questions, questions would become 100%.

So for an individual who has filled in their profile for Boston only with 100% of profile and place data if they are searching for a restaurant in Detroit and there are no place data connections the search would default to 100% profile data place questions. If the individual was not out of the norms of the site in terms of their age, income . . . since there would be no questions that showed superior affinity for the user they would be presented with restaurants that had the most matches on any level or just the restaurants with the most site activity. The more the site is used the less this will be the case.

In the event there were common matches with the individual's place data and profile questions here is how the math would work:
Place data highest restaurant site matches
Restaurant A=151 score*80%/# of restaurants (5)
Restaurant B=119 score*80%/# of restaurants (5)
Restaurant C=103 score*80%/# of restaurants (5)
Restaurant D=91 score*80%/# of restaurants (5)
Restaurant E=63 score*80%/# of restaurants (5)
Profile questions where different from norm
Age—21=50 points*20/# of questions with significant variances from site (3)
Income—low=40 points*20/# of questions with significant variances from site (3)
Taste—=30 points not in tune with most of the site*20/# of questions with significant variances from site (3)

| | % of | %/# of | | |
|---|---|---|---|---|
| Score | total | objects | Score | Order of Search results |
| 151 | 80 | 16 | 2416 | Present Restaurant A first |
| 119 | 80 | 16 | 1904 | Present Restaurant B second |
| 103 | 80 | 16 | 1648 | Present Restaurant C third |
| 91 | 80 | 16 | 1456 | Present Restaurant D fourth |
| 63 | 80 | 16 | 1008 | Present Restaurant E fifth |
| | | | 0 | |
| 100 | 20 | 7 | 667 | Present Restaurant that clusters |
| | | | | with first question sixth |
| 40 | 20 | 7 | 267 | Present Restaurant that clusters |
| | | | | with first question seventh |
| 30 | 20 | 7 | 200 | Present Restaurant that clusters |
| | | | | with third question eighth |
| | | | 9565 | |

### EXAMPLE 6-K

### Optimal Pattern Recognition

Everyone is different and the site will be most successful when it has the ability to recognize people's individual differences and give them more accurate search results based on the differences. For example one user, Ted, may cluster exceptionally well with people 30 to 50 in a certain income bracket from certain zip codes so much so that these 3 questions can have a 30% weight on his algorithm. His Profile may have information that is highly predictive in 3 categories but site usage may be a better predictor in 4 other categories as Ted represents certain favorites on his profile but is actually privately for example much less lavish in his spending so for 3 categories profile data my be 50%, 3 questions may be 30% and site usage may be 20% whereas for other categories site usage may be 55%, questions may be 35% and profile may be 10%. The more the site learns how to recognize patterns unique to individuals the more customized and auto updating algorithms can be and the more precise and valuable the sites' recommendations will be.

The site can collect, batch and update of site usage data to customize the algorithm to each individual logged in to identify their specific preferences and drivers. For example, for some members or sessions site usage data may not be used at all and the results and affinity will be solely determined from the use of their rateables and their answers to questions that are shown to have a predictive impact. Since the algorithm has the ability to be dynamic and adaptive, other times site usage data may properly account for 35% of the algorithm, with profile data accounting for 50% and questions 15% and this may or may not change as we collect more site usage data, to test this we would go back and increase or decrease relative weightings on quick experimental basis and see from the search results, i.e. longer session times, more page views, more actions such as forward to a friend, whether the change worked or did not work and quickly make modifications.

LikeMe can ultimately give members and visitors more control of their own customized algorithms and of their search results by enabling them to search either by a subset of questions and search criteria or by one or a set of people and places and things, the more control users will have, the more they will employ search patterns that provide them with superior results, the more they will use the site and the more successful the site will be. It's never a limitation of one way to search and one set of results. It's an evolution of increasing user control of the search criteria and modifying their search parameters and conducting different types of searches on different occasions to get the best results for each individual user at each point in time.

Smart Learning Algorithm—the more you use LikeMe the more data the site has to feed its algorithm and understand when and why it is presenting you with data you like or do not like and learn your preferences so the site improves in its accuracy with the more rateables data you provide and, or, the more activity on the site you have.

What is claimed is:

1. A photo-based content discovery and recommendation system, executable by a computer, for internet users comprising,
(a) a database;
(b) a logic for creating personal profile in the database based on inputs from a first user;
(c) a logic for determining a degree of likes and preferences for each item listed in the first user's personal profile; and
(d) a logic for discovering and recommending the items listed in the first user's personal profile from the database to a second user.

2. The system of claim 1, wherein said database comprises a collection of pre-selected personal profiles.

3. The system of claim 1, wherein said database comprises a collection of pre-selected items.

4. The system of claim 1, wherein the items are selected from the group consisting of hotels, bars, restaurants, activities, and any combinations thereof.

5. The system of claim 1, further comprising a logic of showing the users' relationships to each other in the database.

6. The system of claim 1, wherein the database comprises at least one pre-populated archetypes of profiles for a particular city.

7. The system of claim 1, further comprising a logic to create or refine an archetype from search results.

8. The system of claim 1, wherein the items listed in the first user's profile appear as photo contact sheet and arranged in different categories.

9. The system of claim 8, wherein the categories include hotels, bars, restaurants, and activities.

10. The system of claim 1, further comprising a search engine providing capability to search for things that relate to other users.

11. A photo-based method for content discovery and recommendation, comprising.
(a) creating a personal profile based on inputs from a first user;
(b) storing the personal profile in a database;
(c) determining a degree of likes and preferences for each item listed in the first user's personal profile;
(d) showing the degree of likes and preferences in the first user's personal profile to a second user;
wherein the method is executable by a computer;
wherein the method uses internet for obtaining information of the items.

12. The method of claim 11, wherein said database comprises a collection of pre-selected personal profiles.

13. The method of claim 11, wherein said database comprises a collection of pre-selected items.

14. The method of claim 11, wherein the items are selected from the group consisting of hotels, bars, restaurants, activities, and any combinations thereof.

15. The method of claim 11, further comprising the step of showing the users' relationships to each other in the database.

16. The method of claim 11, wherein the database comprises at least one pre-populated archetypes of profiles for a particular city.

17. The method of claim 11, further comprising the step of creating or refining an archetype from search results.

18. The method of claim 11, wherein the items listed in the first user's profile appear as photo contact sheet and arranged in different categories.

19. The method of claim 17, wherein the categories include hotels, bars, restaurants, and activities.

20. The method of claim 11, further comprising the step of allowing a user to use a search engine providing capability to search for things that relate to other users.

21. The method of claim 11, further comprising the step of transferring the personal profile in the database into a storage facility.

22. A photo-based content discovery and recommendation system, executable by a computer, for internet users comprising:
(a) a database comprising a plurality of pre-selected personal profiles;
(b) a logic for determining a degree of likes and preferences for each item listed in the pre-selected personal profiles;
(c) a logic for enabling the users to perform internet searches based on the likes and preferences for at least one of the pre-selected personal profiles; and
(d) a logic for recommending items to the users based on the at least one of the pre-selected personal profiles.

23. The system of claim 22, wherein the recommended items of step (d) are determined to be liked by all pre-selected personal profiles used in step (c).

24. A photo-based method for content discovery and recommendation, comprising,
(a) creating a plurality of pre-selected personal profiles;
(b) storing the pre-selected personal profiles in a database;
(c) determining a degree of likes and preferences for items listed in the pre-selected personal profiles;
(d) enabling an internet user to perform internet searches based on the likes and preferences for at least one of the pre-selected personal profiles; and
(e) recommending items to the users based on the at least one of the pre-selected personal profiles;
wherein the method is executable by a computer;
wherein the method uses internet for obtaining information of the items.

25. The method of claim 24, wherein the recommended items of step (e) are determined to be liked by all pre-selected personal profiles used in step (d).
